(19) United States
(12) Patent Application Publication
(10) Pub. No.: US 2012/0185282 A1
(43) Pub. Date: Jul. 19, 2012

(54) Method of Managing a Driver Rewards Programme and a System Therefor

(75) Inventors: Adrian Gore, Sandton (ZA); Barry Swartzberg, Sandton (ZA)

(73) Assignee: DISCOVERY HOLDINGS LIMITED, Sandton (ZA)

(21) Appl. No.: 13/386,431

(22) PCT Filed: Apr. 14, 2011
(86) PCT No.: PCT/IB11/51627

§ 371 Date: Apr. 5, 2012

(30) Foreign Application Priority Data
Apr. 14, 2010 (ZA) 2010/02598
Jul. 28, 2010 (ZA) 2010/05379
Aug. 3, 2010 (ZA) 2010/05533
Feb. 16, 2011 (ZA) 2011/01241

(51) Int. Cl. G06Q 40/08; G06Q 99/00

(52) U.S. Cl. 705/4; 705/1.1

(57) ABSTRACT

A method and system of managing Fog an insurance scheme includes receiving driver data including information relating to the compliance of a driver in at least one programme area related to motor vehicle driver behaviours and storing the data in a database. Wellness programme data is also received indicating the compliance of the driver with a wellness programme and stored in the database and the driver data and wellness programme data are used to determine a reward for the driver.

### BACKGROUND OF THE INVENTION

The present invention relates to a method of managing a driver rewards programme and a system therefor, particularly by an insurance scheme for a motor vehicle.

Drivers of motor vehicles are not motivated in any meaningful way to improve their driver behaviours thereby aiming toward safer driving.

In addition, the health of the driver is not considered in any way especially given that healthy drivers are less likely to have accidents.

The present invention seeks to address this.

### SUMMARY

According to one example embodiment there is provided a method of managing an insurance scheme, the method including:
receiving driver data including information relating to the compliance of a driver in at least one programme area related to motor vehicle driver behaviours and storing the data in a database;
receiving wellness programme data indicating the compliance of the driver with a wellness programme and storing the data in a database; and
using the driver data and wellness programme data to determine a reward for the driver.

The plurality of programme areas may include at least some of vehicle maintenance, driver education, vehicle insurance claims and driving performance.

Alternatively, the plurality of programme areas include all of vehicle maintenance, driver education, vehicle insurance claims and driving performance.

The programme area of vehicle maintenance may include one or more of servicing the vehicle, checking the vehicle and checking the vehicles tyres.

The programme area of driver education may include one or more of a driving course, a driver assessment, a periodic driver quiz and a carbon footprint calculation.

The programme area of vehicle insurance claims may include the number of claim free years.

The programme area of driving performance may include monitoring the manner in which a motor vehicle is driven.

In one example, the manner in which the motor vehicle is driven is monitored by:
obtaining driver data from a device associated with a motor vehicle to be driven by the driver; and
analysing the driver data to determine the manner in which the motor vehicle has been driven for a past predetermined period.

The method may further include:
awarding points to the driver for compliance with the wellness programme;
awarding points to the driver for compliance within the at least one programme area related to motor vehicle driver behaviours; and
at predetermined intervals, calculating the total number of points awarded to the driver, wherein the greater the number of points the greater the reward.

The reward may be a reduced premium to be paid to an insurer for insurance of a motor vehicle.

Alternatively or in addition the reward may be a reduced amount of an excess to be paid in the event of a claim to an insurer.

According to another example embodiment there is provided a system for managing a rewards programme, the system including:
a receiving module for receiving driver data including information relating to the compliance of a driver in at least one programme area related to motor vehicle driver behaviours and for receiving wellness programme data indicating the compliance of the driver with a wellness programme; and
a calculation module for using the data to determine a reward for the driver.

### BRIEF DESCRIPTION OF THE DRAWINGS

FIG. 1 illustrates an example system environment in which the present invention is implemented;

FIG. 2 is a block diagram illustrating an example system to implement the methodologies described herein; and

FIG. 3 is a block diagram illustrating an example embodiment method.

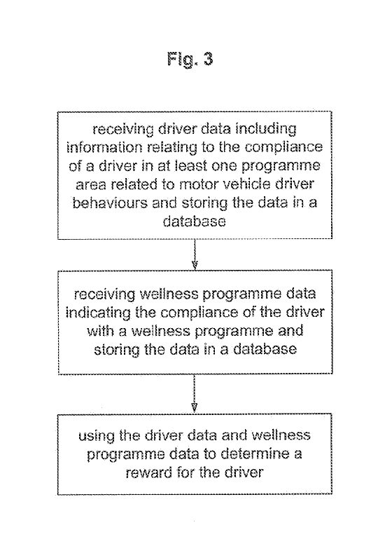

### DESCRIPTION OF EMBODIMENTS

The present invention relates to a method of managing a rewards programme and a system therefor, particularly a rewards implemented by an insurance scheme for a motor vehicle.

Various insurance schemes are known to insure motor vehicles in the event of an accident or against theft, for example.

These insurance schemes typically have the owner of the motor vehicle as the insured person. The insured person pays a premium to the insurer to insure the motor vehicle against an insured event such as an accident or against theft, for example.

The quantum of the premium is usually determined using a number of factors such as the value of the motor vehicle and in certain cases the driver's age.

The above factors are also used to determine an excess which is a first amount paid by the insured person in the event of a claim before the insurer pays towards the claim.

However, these insurance schemes do not take into account driver behaviour nor vehicle mechanical condition in any meaningful way when determining the obligations of the motor vehicle owner to the insurer.

Neither do these prior art methodologies take into account the health of the driver, more specifically whether the driver leads a healthy lifestyle. Drivers of poor health are more likely to have accidents than drivers in good health. However this has never been addressed before.

A system and method for addressing this is described below.

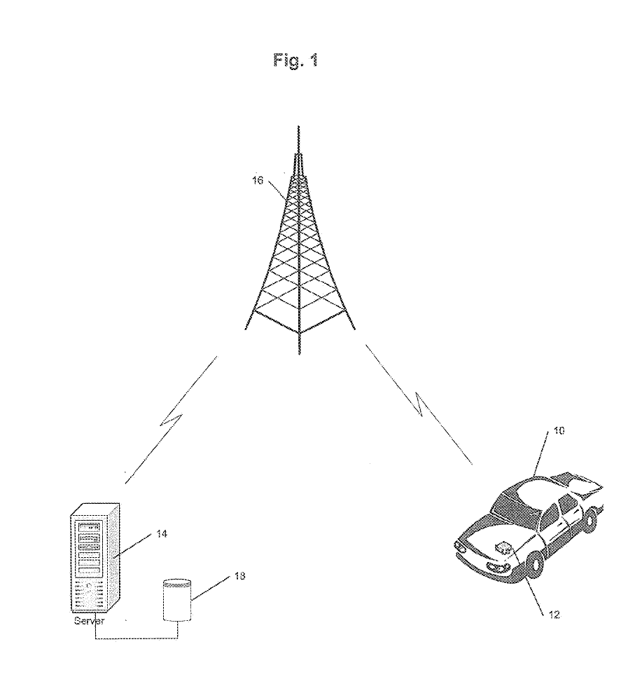

Referring to FIG. 1, a motor vehicle 10 is fitted with a telemetry device 12.

The telemetry device 12 is used to monitor a number of aspects of the use of the motor vehicle.

For example, the device monitors the speed at which the vehicle is travelling and can therefore calculate average speed and maximum and minimum speeds, for example.

Where the device includes GPS functionality, for example, the device is able to determine if speed limits on a particular road have been exceeded.

The device is also able to determine braking habits of the driver either using the GPS functionality or by using an accelerometer or having one or more sensors connected to the vehicle or to a deceleration detection device, for example.

The device is also typically able to detect the distance travelled and if the driver has driven the vehicle for a long time period without a break.

In addition, the times of the day that the vehicle is being driven can be captured as night time driving is statistically more dangerous than day time driving, especially weekend late night driving.

In addition to the above, the device will have the ability to detect the driver's use of the vehicle including braking, indicating and accelerating to name a few examples. Thus it could be determined when the vehicle turns without indicating, for example.

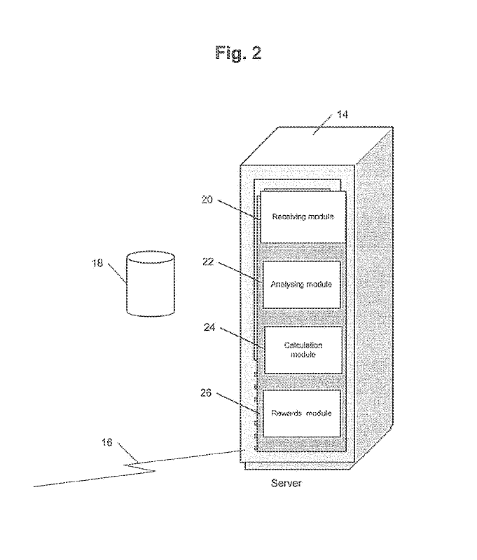

Referring to FIG. 2, a server 14 includes a number of modules to implement the present invention.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In any event, the data from the device 12 is transmitted to a receiving module of the server 14 over a communication network 16.

It will be appreciated that this could be accomplished in a number of ways. For example, the data could be transmitted via a communication network 16 as illustrated in the accompanying drawing. This communication network could be any suitable kind of communication network such as a mobile communication network, a wireless communication network, a satellite communication network or a combination of these to name but a few examples.

Alternatively, the device 12 could be connected to another intermediate device which downloads the data and transmits the data via the communication network 16 to the server 14. One example of this could be connecting the device 12 to a USB port of a computer and downloading the data to the computer, which data is then transmitted over the Internet to the server 14.

In one example embodiment, the data is transmitted over a cellphone networks using the short message service (SMS) protocol.

It will be appreciated that the data could be transmitted at any suitable time to the server. For example, the data could be transmitted in real time or near real time or could be transmitted periodically such as daily, weekly or monthly to name a few examples.

The method may further include motivating the insured person to improve other driver related behaviours.

In this example embodiment, the receiving module 20 receives compliance data containing information relating to the compliance of a driver in at least one of a plurality of programme areas related to motor vehicle driver behaviour.

The compliance data is stored in a memory 18 typically in the form of a database 18.

The analysing module 22 analyses the compliance data to determine driver behaviour. This will be described in more detail below.

The calculation module 24 awards points to the driver wherein the points allocated are related to the compliance of the driver in one or more of the programme areas. An example of this is described below.

Finally, the points allocated are used by a rewards module 26 to determine a reward for the driver will also be described in more detail below.

The plurality of programme areas includes at least some of vehicle maintenance, driver education, vehicle insurance claims, premium payments, policy updates and driving performance.

In one example embodiment, the plurality of programme areas includes all of the abovementioned programme areas.

The programme area of vehicle maintenance includes one or more of servicing the vehicle, checking the vehicle and checking the vehicles tyres.

Describing these programme areas in more detail, servicing the vehicle means that the driver has taken the vehicle to a mechanical workshop for a periodic service to ensure that the vehicle is in good working order. Typically in such services oil and other lubricants are changed, brake pads are changed if required and any other mechanical faults that have arisen in the past period are fixed.

The programme area of checking the vehicle entails taking the vehicle to an authorised centre were a number of checks on the different parts of the vehicle are conducted to ensure that the vehicle is in good working order. If anything is found to be not correct, the driver will be instructed to take the vehicle to a workshop for fixing and may be awarded further points for this step.

New vehicles may be exempt from the service check for the first year and the insured person will be awarded these points on submission of proof that the vehicle is within its first year since its first registration.

Checking the vehicle tyres entails either having the tyres checked as part of the above-mentioned checking of the vehicle or alternatively, taking the vehicle to a specialist tyre centre to have the tyres checked.

In one example embodiment, an interface is created between the server 14 and checking centre via the communications network 16 so that the checking centre can confirm the results of the check.

In addition to the tyre check the steering, windscreen wipers, lights, seatbelts, hooter and shock absorbers can be checked at this time.

Bonus Points can be awarded for all of these being in an acceptable condition.

In all of these cases, the party doing the checking or servicing will capture data relating to the vehicle and/or driver and periodically transmit this data to the receiving module 20.

The programme area of driver education includes one or more of a driving course, a driver assessment, a periodic driver quiz and a carbon footprint calculation.

Driving courses are attended by drivers to improve their driving skills and particularly to learn so-called defensive driving skills.

A driver assessment is conducted in one example embodiment by an assessor taking the driver in the vehicle onto the road and assessing the driving skills and habits of the driver.

Weaknesses in the skills or habits of the driver may be pointed out and the driver given the opportunity to correct these in the coming weeks or months before returning for an updated assessment.

In one example, the driver is given an assessment score.

In another example, the driver assessment is an online questionnaire designed to highlight certain risks relating to a driver.

In this example, the questionnaire includes two sections namely. ‘Driving habits’ and ‘State of Vehicle’. For example a question of whether one uses a cellular telephone to send messages while driving will be asked. At the end of the questionnaire (approximately 20 questions) the driver will receive feedback explaining their risk and suggesting ways to mitigate their risks.

Based on the answers received a calculation will be performed to consider the driver's risk relative to an average driver. The results can be illustrated to the driver on two risk bars. One illustrates how risky the driver's habits are, and one illustrates risks relating to the state of the drivers vehicle.

A third risk bar may also be included illustrating a combined risk score.

In addition, the questionnaire may include educational information to address specific areas such as how to drive in wet weather or what to do in the event of an accident. The format will be a paragraph followed by a question relating to the paragraph

In this example, the driver will typically use a user interface device in the form of a computer with a screen on which is displayed a template for the driver to capture answers to questions put to them.

The answers are captured and transmitted to the server 14.

Alternatively, the server 14 accesses driver information stored in the database 18 and obtains the driver's e-mail address.

An e-mail is then sent to the retrieved e-mail address. When the driver opens the e-mail a template is displayed to them asking them the relevant questions with options to select various scores.

A driver, will send the e-mail back to the server 14 via a communications network and the receiving module 20. These will be received and written to the database.

The programme area of premium payments relates to the quantum and frequency with which the premium payments are made and if they are made on time or not and the programme area of policy updates relates to whether or not the insured person is updating their policy to accurately reflect what is being insured by the insured person.

The programme area of vehicle insurance claims includes the number of claim free years on the motor vehicle insurance policy. No fault claims where the driver was not at fault typically will not be calculated as a claim for this.

The programme area of driving score includes monitoring the manner in which the motor vehicle is driven as has been described above.

As described above, receiving module 20 receives the data and writes the data to database 18.

Once the server 14 receives the driver data it will analyse the data. To do this the server includes an analysing module 22 which access the database 18 and retrieves the data stored therein.

The retrieved data is then used to calculate a number of factors depending on the requirements of the insurers.

For example, the data received from the device may include one or more of speed related data, time of day or night data indicating what time the vehicle is driven, duration information data relating to the duration of time that the vehicle is driven without the driver thereof taking a break and distance information data including the distance that the vehicle travels over a period of time such as a month.

The speed related data may include one or more of the average speed that the vehicle is driven and the number of times that the vehicle exceeds a speed limit on a road on which the vehicle is travelling.

In one example embodiment points are awarded to each of a number of sub-categories. Thus, points are awarded to the sub-category of speed which points are then used to determine an overall score. It will be appreciated that the scoring could be arranged that a higher score is a successful score or that a lower score is a successful score. In the illustrated embodiments described herein a higher score will be deemed a better score than a lower score.

Thus using the example of speed, the driver is allocated an amount of points if they never exceed the speed limit. Every infraction of the speed limit would result in a loss of points.

Similarly, for example, no night driving would result in a maximum score whilst a large amount of night driving would result a zero or even a minus score.

An example of how the calculation module 24 then awards points is as follows:

| | Driver Category | Points | Frequency |
|---|---|---|---|
| Driving score | No Star (no telematics device) | | Monthly |
| | * | — | |
| | ** | 100 | |
| | *** | 350 | |
| | **** | 800 | |
| Road worthy | Annual Service | 50 | Annual |
| | Multi Point Check | 50 | |
| | Multi point check bonus points | 100 | |
| Education | Defensive driving course | 150 | Every 3 |
| | | | years |
| | Driver Assessment | 50 | Annual |
| | Quarterly quiz | 75 | ¼ly |
| | Carbon footprint calculated | 50 | Monthly |
| Claim Free Years | 1 | 25 | Monthly |
| | 2 | 50 | |
| | 3+ | 100 | |

It will be appreciated that the actual number of points allocated may change and other categories may be introduced.

In one example embodiment the number of points is used to determine a driver status. An example driver status is as follows:

| Driver Status | |
|---|---|
| Red | 0 |
| Amber | 300 |
| Green | 600 |
| Double Green | 1000 |

It will be appreciated that the way in which the points are allocated and driver status determined could be varied. However, in an example embodiment the status will be determined periodically, for example every month.

At the beginning of every calendar month the driver's points are zeroed and drivers will then be awarded points for having done a multi point check, annual service, driver assessment or carbon footprint calculation within the previous 12 months.

Similarly quarterly quiz points will be awarded provided the questionnaire has been done for that quarter.

Defensive driving courses need to be completed every 3 years or any other specified period to earn points and if a defensive driving course has been completed in the past 3 years then the relevant points will be added to the driver score for the present month.

If confirmation of these point earning events are received midmonth then points will be awarded immediately therefore contributing to the driver status in that month.

On the last day of each month the driver's telematic data or a telematic score will be received and points award points accordingly.

If multiple vehicles are insured then one method of dealing with this is to use a weighted average to calculate a single score calculated.

This will complete the driver's points for the month which will be added together to get the driver status for that month.

The above method is integrated with a lifestyle or wellness programme.

An example of such a wellness program is presently managed by the applicant that manages a traditional life and health insurance plan together with their wellness program disclosed in the applicant's South African granted patent number ZA 99/1746 and the commonly owned U.S. Patent Application Ser. No. 09/982,274, which are both hereby incorporated by reference in their entireties.

In an example wellness program, members participate in approved related facilities and/or services. For example, members use gymnasiums, Smoke Enders™ and Weighless™.

In one example, members are awarded points and depending on the total number of points allocated to a member, they fall within one of five statuses. In the implementation of the wellness program, these statuses have been named in ascending order of value, blue, bronze, silver, gold and diamond. All members are placed initially in the blue status. Once a member has accumulated a predetermined number of points, his/her status is upgraded to the next appropriate level.

It is the status level that is then used to determine the one or more obligations of the owner of the motor vehicle to the insurer.

It will be appreciated that for purposes of the present invention the wellness programme could be operated by the insurer or could be operated by a third party that operates the wellness programme and then informs the insurer of the degree of participation of the insured person with the wellness programme.

This could occur by a third party transmitting data to the server 14 (FIG. 2) operated by the insurer. The data is received at the server 14 and stored in database 18 associated with the server.

In one example the data will include at least an identity of the insured person and data identifying the status of the insured person, for example blue, bronze, silver, gold and diamond.

In order to determine the status, monitoring of the compliance of the insured person with the wellness programme includes receiving insured person usage information associated with the insured person's usage of the wellness program and determining, based on the usage information, a status level associated with the insured person for the wellness program, wherein the status level indicates a degree of participation in the wellness program

The usage information received may include information associated with a plurality of separate and distinct occurrences of wellness program participation by the insured person.

In addition, the method may further include determining a wellness status level associated with the insured person that further includes receiving the usage information from an information processing system and assigning a given point value to each separate and distinct occurrence of wellness program participation.

A total point value is determined based on an accumulation of each given point value assigned to each separate and distinct occurrence of wellness program participation.

In one example, the total point value is used together with the driver data to determine the reward.

In another example, the total point value is compared to a plurality of point ranges, each point range in the plurality of point ranges being associated with a status level and identifying a point range in the plurality of point ranges corresponding to the total point value.

Finally, a wellness status level is assigned depending on the total point value and the wellness status level is used together with the driver data to determine the reward.

After calculating the score and associated status, the calculation module 24 uses the driver status together with the wellness status to calculate a reward for the insured person.

In one example embodiment, the reward is a petrol cash back where the amount of petrol spent in a prior period is paid back to the insured person. This can either be paid back to an account of the insured person or in a preferred embodiment a credit is issued to a credit or debit card that the insured person has used to purchase petrol.

It will be appreciated that while in this example petrol has been referred to, this applies equally to any other type of vehicle fuel.

In one example embodiment, calculation module 24 accesses data stored on the database 18 relating to historic petrol spend using a credit or debit card. In one example the historic spend is for a calendar month period but it will be appreciated that this could be any period of time.

The calculation module 24 then uses this to calculate the reward to the insured person and an example is set out in the table below:

| | Petrol Cash Back Percentage | | | | |
|---|---|---|---|---|---|
| Driving score | Blue | Bronze | Silver | Gold | Diamond |
| Red | 2% | 2% | 2% | 2% | 2% |
| Amber | 5% | 5% | 10% | 20% | 30% |
| Green | 12.5% | 15% | 20% | 30% | 50% |
| Double Green | 17.5% | 25% | 30% | 40% | 60% |
| Triple Green | 25% | 30% | 40% | 60% | 100% |

A rewards module 26 then effects the reward. In one example embodiment this could be done by communicating with a financial institution via the communications network 16 and instructing the financial institution to implement the cash back.

In other example embodiments, the reward could take another form, for example a discount on an insurance premium payable on an insurance agreement for a motor vehicle where the amount of the discount depends on the driver status and the wellness status referred to above.

In another example, a retail reward may be implemented. One example of implementing a retail reward is that each insured person will be eligible to apply for a credit card from a company associated with the rewards company.

This will entitle them to retail partner cash backs for spending at retail partners associated with the credit card company.

Another example would be to use a non-transactional card to capture retail spend and then refund the insured person based on the retail spend captured by transferring funds into a bank account of the insured person.

In any event, this can be implemented by communicating with a financial institution via the communications network 16 and instructing the financial institution to implement a cash back by paying an amount into the driver's bank account or onto their credit or debit card.

In another example embodiment the financial institution pays the funds over to a short term insurer which funds are then used to reduce the insurance premium payment on the motor vehicle that the driver pays a short term insurer.

In order to implement this, the system instructs a financial institution to pay on an amount to the bank account of the short term insurer. A data message with information detailing the amount transferred and details of whom it is transferred for is sent to a system of the short term insurer so that they are able to keep track of premiums owed to them by the insured person for the motor vehicle insurance.

Thus it will be appreciated that the person is motivated to not only improve their driver behaviours but also to look after their health. This aims to reduce their risk of having an accident.

In addition, there's a thinking that suggests that a person who takes care of his health is also likely to be observant about his driving habit and thus becomes a better risk for the insurance company.

This helps ensure the driver's safety while at the same time results in reduced claims to the insurer and is therefore beneficial to all parties.

1-21. (canceled)

22. A method of managing a rewards programme, the method including:
receiving, by a computer, driver data including information relating to the compliance of a driver in at least one programme area related to motor vehicle driver behaviours and storing the data in a database;
receiving, by the computer, wellness programme data indicating the compliance of the driver with a wellness programme and storing the data in a database; and
using, by the computer, the driver data and wellness programme data to determine a reward for the driver.

23. The method according to claim 22 wherein the at least one programme area includes at least some of vehicle maintenance, driver education, vehicle insurance claims and driving performance.

24. The method according claim 23 wherein the at least one programme area includes all of vehicle maintenance, driver education, vehicle insurance claims and driving performance.

25. The method according to claim 23 wherein the programme area of vehicle maintenance includes one or more of servicing the vehicle, checking the vehicle and checking the vehicles tires.

26. The method according to claim 23 wherein the programme area of driver education includes one or more of a driving course, a driver assessment, a periodic driver quiz and a carbon footprint calculation.

27. The method according to claim 23 wherein the programme area of vehicle insurance claims includes the number of claim free years.

28. The method according to claim 23 wherein the programme area of driving performance includes monitoring the manner in which a motor vehicle is driven.

29. The method according to claim 28 wherein the manner in which the motor vehicle is driven is monitored by:
obtaining driver data from a device associated with a motor vehicle to be driven by the driver; and
analysing the driver data to determine the manner in which the motor vehicle has been driven for a past predetermined period.

30. The method according to claim 22 further including:
awarding points to the driver for compliance with the wellness programme;
awarding points to the driver for compliance within the at least one programme area related to motor vehicle driver behaviours; and
at predetermined intervals, calculating the total number of points awarded to the driver, wherein the greater the number of points the greater the reward.

31. The method according to claim 22 wherein the reward is a reduced premium to be paid to an insurer for insurance of a motor vehicle.

32. The method according to claim 22 wherein the reward is a reduced amount of an excess to be paid in the event of a claim to an insurer.

33. A computer system for managing a rewards programme, the system including:
a receiving module for receiving driver data including information relating to the compliance of a driver in at least one programme area related to motor vehicle driver behaviours and for receiving wellness programme data indicating the compliance of the driver with a wellness programme; and
a calculation module for using the data to determine a reward for the driver.

34. The computer system according to claim 33 wherein the reward determined by the calculation module includes a reduction in the amount of a premium to be paid to an insurer for the insurance of a motor vehicle.

35. The computer system according to claim 33 wherein the reward determined by the calculation module includes the amount of an excess to be paid in the event of a claim to the insurer.

36. The computer system according to claim 33 wherein the at least one programme area includes at least some of vehicle maintenance, driver education, vehicle insurance claims and driving performance.

37. The computer system according to claim 33 wherein the at least one programme area includes all of vehicle maintenance, driver education, vehicle insurance claims and driving performance.

38. The computer system according to claim 36 wherein the programme area of vehicle maintenance includes one or more of servicing the vehicle, checking the vehicle and checking the vehicles tires.

39. The computer system according to claim 36 wherein the programme area of driver education includes one or more of a driving course, a driver assessment, a periodic driver quiz and a carbon footprint calculation.

40. The computer system according to claim 36 wherein the programme area of vehicle insurance claims includes the number of claim free years.

41. The computer system according to claim 36 wherein the programme area of driving score includes monitoring the manner in which the motor vehicle is driven.

42. The computer system according to claim 36 further wherein:
the receiving module obtains driver data from a device associated with a motor vehicle; and
an analysing module analyses the data to determine the manner in which the motor vehicle has been driven for a past period to determine driving performance.
